(19) United States
(12) Patent Application Publication
(10) Pub. No.: US 2024/0005915 A1
(43) Pub. Date: Jan. 4, 2024

(54) METHOD AND APPARATUS FOR DETECTING AN INCONGRUITY IN SPEECH OF A PERSON

(71) Applicant: Uniphore Technologies, Inc., Palo Alto, CA (US)

(72) Inventors: Lucia POZZAN, Palo Alto, CA (US); Basuraj AGRAWAL, Palo Alto, CA (US)

(21) Appl. No.: 17/855,754

(22) Filed: Jun. 30, 2022

(51) Int. Cl. G10L 15/18; G10L 15/22; G10L 25/63; G06F 40/30

(52) U.S. Cl. CPC G10L 15/1815; G06F 40/30; G10L 25/63; G10L 15/22

(57) ABSTRACT

A method and an apparatus for detecting an incongruity in a speech, for example, in a conversation between a customer and an agent of a call center, or any other speech is provided. The method includes a processor comparing a sentiment score and an emotion score of a portion of a speech. The sentiment scores are based on the text in the portion, while the emotion scores are based on the tonal data of the portion, and the processor identifies an incongruity if the sentiment score does not correlate with the emotion score.

### FIELD

The present invention relates generally to speech audio processing, for example, in call center management systems, and particularly to detecting incongruities in speech.

### BACKGROUND

Several businesses need to provide support to their customers, which is provided by a customer care call center operated by or on behalf of the businesses. Customers place a call to the call center, where customer service agents address and resolve customer issues. The agent uses a computerized call management system used for managing and processing calls between the agent and the customer. The agent is expected to understand the customer's issues, provide appropriate resolution, and achieve customer satisfaction.

Call management systems may help with an agent's workload, complement or supplement an agent's functions, manage agent's performance, or manage customer satisfaction, and in general, such call management systems can benefit from understanding the content of a conversation, including entities, customer intent. Conventional systems are deficient in detecting nuances or incongruities, such as sarcastic or ironical comments, or otherwise deviations from standard speech patterns, which may lead to incorrect identification of intent and/or entities or other failures to comprehend a conversation appropriately.

Accordingly, there is a need in the art for method and apparatus for detecting incongruities in speech.

### SUMMARY

The present invention provides a method and an apparatus for detecting incongruities in speech, substantially as shown in and/or described in connection with at least one of the figures, as set forth more completely in the claims. These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts an apparatus for detecting incongruities in speech, in accordance with an embodiment of the present invention.

FIG. 2 is a flow diagram of a method for detecting incongruities in speech, for example, as performed by the apparatus of FIG. 1, in accordance with an embodiment of the present invention.

FIG. 3 depicts a graphical user interface (GUI) of the apparatus of FIG. 1, in accordance with an embodiment of the present invention.

### DETAILED DESCRIPTION

Embodiments of the present invention relate to a method and an apparatus for detecting incongruities in speech, for example, in a conversation between a customer and an agent of a contact/call center, over an audio or multimedia call between the agent and the customer, or an audio and/or video of any other dialogue or monologue containing speech. In several scenarios, words are spoken to convey a meaning different than the literal meaning of the words. For example, if a customer wishes to change a flight reservation to a specific date, and an agent of the airline informs the customer that the flight is unavailable, the customer may sometime respond sarcastically and say “that is fabulous,” but the customer means the exact opposite, that is “that is undesirable.” Similarly, in any speech, for example, a narration, the narrator may highlight irony of a situation such that the spoken words correspond inversely to the implied meaning. In other examples, the spoken word and implied meanings do not correspond or may correspond inversely, and such instances in speech are referred to as incongruities. Incongruities can misguide systems that analyze the speech to determine the intent of the speech or entities therein, for example, automated call management systems in a call center. The disclosed techniques identify incongruities by comparing sentiment scores generated based on the literal text of the speech, and emotion scores generated based on the tonal component of the speech. A high disparity between the sentiment and the emotion score is considered indicative of an incongruity, such as sarcasm, irony and the like. Identified incongruities may be presented to the agent during the call as alerts or included in report for performance assessment and training purposes after the call is concluded, among several other chronologies. In some embodiments, one or more steps described herein are performed in real-time, that is, as soon as practicable, in some embodiments, in near real-time, that is with delays of about 5 seconds to about 12 seconds, and in some embodiments one or more steps are performed with other predefined delays.

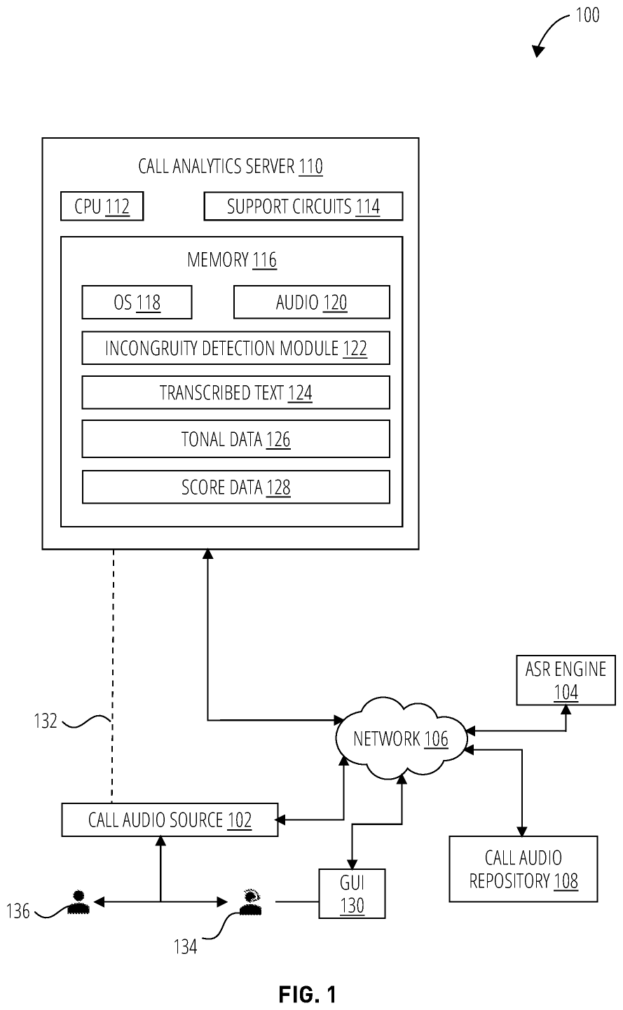

FIG. 1 is a schematic diagram depicting an apparatus 100 for detecting incongruities in speech, in accordance with an embodiment of the present invention. The apparatus 100 comprises a call audio source 102, an automatic speech recognition (ASR) engine 104, a call audio repository 108, and a CAS 110, each communicably coupled via a network 106. In some embodiments, the call audio source 102 is communicably coupled to the CAS 110 directly via a direct link 132, separate from the network 106, and may or may not be communicably coupled to the network 106.

The call audio source 102 provides audio of a call to the CAS 110. In some embodiments, the call audio source 102 is a call center providing live or recorded audio of an ongoing call between a call center agent 134 and a customer 136 of a business which the call center agent 134 serves. In some embodiments, the call center agent 134 interacts with a graphical user interface (GUI) 130 for providing inputs and viewing outputs. In some embodiments, the GUI 130 is capable of displaying an output, for example, transcribed text or incongruities therein, to the agent 134, and receiving one or more inputs on the transcribed text, from the agent 134. In some embodiments, the GUI 130 is communicably coupled to the CAS 110 via the network 106, while in other embodiments, the GUI 130 is a part of the call audio source 102 and communicably coupled to the CAS 110 via the direct link 132.

The ASR Engine 104 is any of the several commercially available or otherwise well-known ASR Engines, as generally known in the art, providing ASR as a service from a cloud-based server, a proprietary ASR Engine, or an ASR Engine which can be developed using known techniques. ASR Engines are capable of transcribing speech data (spoken words) to corresponding text data (transcribed text, text words or tokens) using automatic speech recognition (ASR) techniques, as generally known in the art, and include a timestamp for some or each token(s). In some embodiments, the ASR Engine 104 is implemented on the CAS 110 or is co-located with the CAS 110, or otherwise as an on premises service.

The network 106 is a communication network, such as any of the several communication networks known in the art, and for example a packet data switching network such as the Internet, a proprietary network, a wireless GSM network, among others. The network 106 is capable of communicating data to and from the call audio source 102 (if connected), the ASR Engine 104, the call audio repository 108, the CAS 110 and the GUI 130.

In some embodiments, the call audio repository 108 includes recorded audios of calls between a customer and an agent, for example, the customer 136 and the agent 134 received from the call audio source 102. In some embodiments, the call audio repository 108 includes training audios, such as previously recorded audios between a customer and an agent, or custom-made audios for training modules, or any other audios comprising speech in which spoken words do not correspond to the implied meaning. In some embodiments, the call audio repository 108 is located in the premises of the business associated with the call center.

The CAS 110 includes a CPU 112 communicatively coupled to support circuits 114 and a memory 116. The CPU 112 may be any commercially available processor, microprocessor, microcontroller, and the like. The support circuits 114 comprise well-known circuits that provide functionality to the CPU 112, such as, a user interface, clock circuits, network communications, cache, power supplies, I/O circuits, and the like. The memory 116 is any form of digital storage used for storing data and executable software, which are executable by the CPU 112. Such memory 116 includes, but is not limited to, random access memory, read only memory, disk storage, optical storage, various non-transitory storages known in the art, and the like. The memory 116 includes computer readable instructions corresponding to an operating system (OS) 118, an audio 120, an incongruity detection module (IDM) 122, transcribed text 124 (or text 124 or transcript 124) of the audio 120, tonal data 126 of the audio 120, and a score data 128.

The audio 120 is any audio including speech of one or more persons, for example, audio of a call between a customer and an agent comprising the speech thereof received from the call audio source 102 or the call audio repository 108. In some embodiments, the audio 120 is not stored on the CAS 110, and instead accessed from a location connected to the network 106.

The IDM 122 corresponds to computer executable instructions configured to perform various actions including detecting incongruity in the speech in the audio 120. The IDM 122 obtains the transcribed text 124 from the ASR Engine 104 or is configured to transcribe the audio 120 to generate the transcribed text 124. The IDM 122 also obtains tonal data 126 from a service (not shown) configured to provide tonal data 126 from the audio 120, or the IDM 122 is configured to extract the tonal data 126 from the audio 120.

The IDM 122 generates a sentiment score from the transcribed text 124. In some embodiments, the sentiment score is generated using known techniques, for example, by scoring each word in the transcribed text 124 corresponding to diarized, speech portions on its sentiment weightage or corresponding intensity measure based on a predefined Valence Aware Dictionary and Sentiment Reasoner (VADER), among others. In some embodiments, sentiment scores are measured on a continuous scale (−1 to 1 or 0 to 1) to indicate positive and negative scores.]. In some embodiments, chunks of about 5 seconds to about 12 seconds duration of the transcribed text 124 are used for generating the sentiment score.

The IDM 122 generates an emotion score from the tonal data 126. In some embodiments, the emotion score is generated using known techniques, for example, by scoring the tonal data 126 based on pitch, harmonics and/or cross-harmonics, and additionally based on speech pauses, speech energy and MFC coefficients. In some embodiments, emotion scores are measured on a continuous scale (−1 to 1 or 0 to 1) to indicate positive and negative scores. In some embodiments, chunks of about 5 seconds to about 12 seconds duration of the tonal data 126 are used for generating the sentiment score.

In some embodiments, the emotion score and the sentiment score are generated on a uniform scale, for example, between 0 and 1. In some embodiments, the emotion score and the sentiment score are generated on different scales, but are converted by the IDM 122 to a uniform scale, such as between 0 and 1 or any other scale. For example, an emotion positivity score of −1 can be transformed into a score of 0 to fit a normalized 0-1 scale by applying one or more standardization techniques as known in the art.

The IDM 122 compares the sentiment score and the emotion score to identify if the sentiment score and the emotion score do not correlate, that is, a disparity exists between the sentiment score(s) and the emotion score(s) for one or more portions of the speech. It is theorized that the sentiment score and emotion score follow similar trends, and disparity therein is indicative of an incongruity. In some embodiments, the IDM 122 identifies the difference between the sentiment score and the emotion score as a measure of lack of correlation between the sentiment score and the emotion score, such that a higher difference indicates a higher lack of correlation or an inverse correlation. For example, the IDM 122 identifies that if the sentiment score is high, whether the emotion score is also high. In some embodiments, if the difference between the sentiment score and the emotion score of a portion satisfies a predefined threshold, for example, the difference is greater than the predefined threshold, the portion is identified as containing an incongruity.

In some embodiments, one or more threshold ranges may be specified, for example, an absolute difference between the sentiment score and the emotion score below 0.49, the incongruity is rated low, between 0.5 to 0.69, the incongruity is rated medium, and 0.7 and above is rated as a high incongruity, for example as shown in Table 1 below. Various ratings, scores, adjusted scores (sentiment, emotion, incongruity) are stored in the score data 128.

TABLE 1

| | | Sentiment | | Tone | Incongruity | Absolute | |
|---|---|---|---|---|---|---|---|
| Sentiment | Sentiment | Score - | | Score | score | Incongruity | Incongruity |
| (A) | Score (B) | Adjusted (C) | Tone (D) | (E) | (F = C − E) | Score (G = \|F\|) | Rating (H) |
| negative | −1 | 0 | Negative | 0 | 0 | 0 | low |
| neutral | 0 | 0.5 | negative | 0 | 0.5 | 0.5 | medium |
| positive | 1 | 1 | negative | 0 | 1 | 1 | high |
| negative | −1 | 0 | neutral | 0.5 | −0.5 | 0.5 | medium |
| neutral | 0 | 0.5 | neutral | 0.5 | 0 | 0 | low |
| positive | 1 | 1 | neutral | 0.5 | 0.5 | 0.5 | medium |
| negative | −1 | 0 | positive | 1 | −1 | 1 | high |
| neutral | 0 | 0.5 | positive | 1 | −0.5 | 0.5 | medium |
| positive | 1 | 1 | positive | 1 | 0 | 0 | low |

For example, in a conversation between an agent of a travel business and a customer of the business, the customer wishes to book a flight on the 22nd, however, the agent informs the customer that there are no available flights on the 2nd. In response, the customer remarks “That's just fabulous.” While the sentiment score for the utterance or speech “That's just fabulous” is high, indicative of a positive sentiment of the customer and therefore a high score of 1, the tone however is negative, and the emotion score is low (for example, 0). Such a high sentiment score and a low emotion score yield a high absolute incongruity score of 1, indicative of a high incongruity, in this case, the sarcastic remark by the customer.

In some embodiments, the IDM 122 is configured to send a notification indicating the detection of an incongruity (for example, the incongruity rating) and/or identification of the associated text to the agent 134, for example, on the GUI 130 via the network 106 or the direct link 132. In some embodiments, the IDM 122 is configured to send one or more identified incongruities to a supervisor of the agent 134 and/or included in a report.

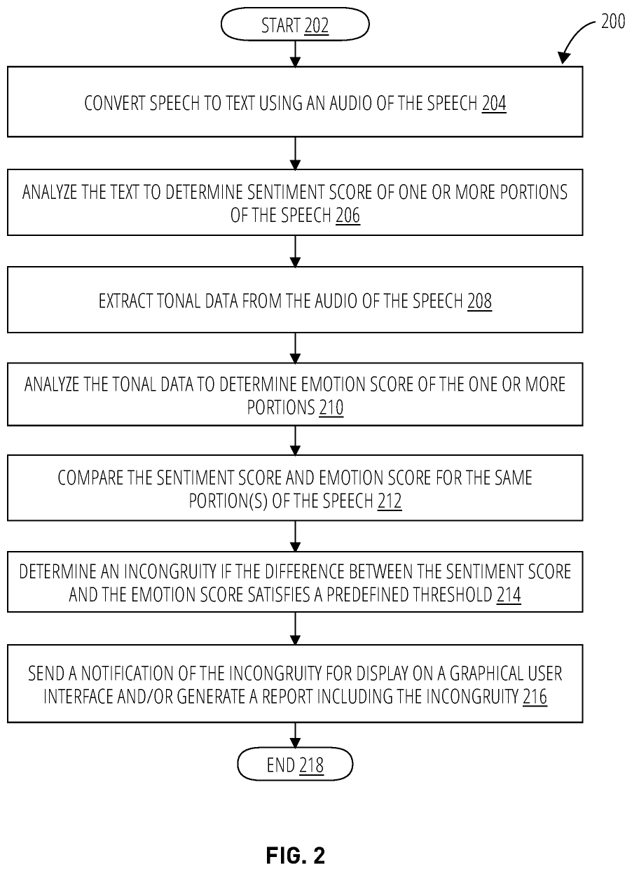

FIG. 2 is a flow diagram of a method 200 for detecting incongruities in speech, for example, as performed by the apparatus 100 of FIG. 1, in accordance with an embodiment of the present invention. In some embodiments, the IDM 122 of the apparatus 100 performs one or more steps of the method 200. The method 200 begins at step 202, and proceeds to step 204, at which the method 200 converts speech to text using an audio, for example, the audio 120 of the speech. At step 206, the method 200 analyzes the text to determine sentiment score of one or more portions of the speech. At step 208, the method 200 extracts tonal data from the audio of the speech. At step 210, the method 200 analyzes the tonal data to determine emotion score of the one or more portions.

At step 212, the method 200 compares the sentiment score and emotion score for a given same portion of the speech. If the sentiment score and the emotion score are not already on the same scale, the two scores are first normalized to be on a uniform scale, for example, between 0 and 1, and then, the difference between the sentiment score and the emotion score is calculated. An absolute value of the difference is determined as the incongruity score, based on which an incongruity rating is assigned to the portion of the speech.

At step 214, the method 200 determines an incongruity if the difference between the sentiment score and the emotion score (incongruity score) satisfies a predefined threshold. For example, in some embodiments, the predefined threshold is satisfied if the incongruity score is about 0.5 or greater, which is flagged as containing an incongruity, and in some embodiments, the predefined threshold is satisfied if the incongruity score is about 0.7 or greater. In some embodiments, the predefined threshold is satisfied as follows: if the incongruity score is about 0.7 is greater, high incongruity; if the incongruity score is between about 0.5 and about 0.69, medium incongruity; and if the incongruity score is 0.49 or less, low or no incongruity. In some embodiments, a low incongruity score indicates a lack of sarcasm or any incongruity in the speech, and may be used to validate that the speaker meant the spoken words.

At step 216, the method 200 sends a notification of the incongruity (including the rating and/or the associated text) for display on a graphical user interface, and/or generate a report including the incongruity. The method 200 then proceeds to step 218, at which the method 200 ends.

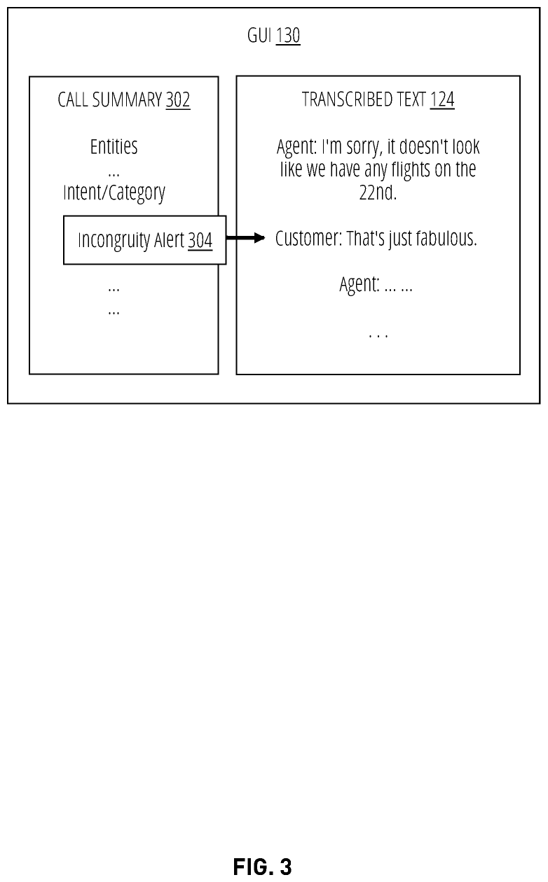

FIG. 3 depicts the GUI 130 of the apparatus 100 of FIG. 1, displaying the notification sent at the step 216 of the method 200, in accordance with an embodiment of the present invention. For example, the GUI 130 is operational to display a call summary 302 and the transcribed text 124 of the call while the call is active. The notification is overlaid on the GUI 130 as an incongruity alert 304, indicating the text corresponding to the portion of the speech that is an incongruity. In the embodiment depicted in FIG. 3, the customer's saying “That's just fabulous” is identified as an incongruity.

While audios have been described with respect to call audios of conversations in a call center environment, the techniques described herein are not limited to such call audios. Those skilled in the art would readily appreciate that such techniques can be applied readily to any audio containing speech, including single party (monologue) or a multi-party speech. Further, the techniques disclosed herein are designed to identify sarcasm, irony and other incongruities that may be encountered in a speech. While specific threshold score values have been illustrated above, in some embodiments, other threshold values may be selected. While various embodiments have been described, combinations thereof, unless explicitly excluded, are contemplated herein.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations, and data stores are somewhat arbitrary, and particular operations are illustrated in the context of specific illustrative configurations. Finally, structures and functionality presented as discrete components in the example configurations may be implemented as a combined structure or component. These and other variations, modifications, additions, and improvements may fall within the scope of embodiments as described.

While the foregoing is directed to embodiments of the present invention, other and further embodiments of the invention may be devised without departing from the basic scope thereof.

I/We claim:

1. A method for detecting an incongruity in a portion of a speech, the method comprising:
a processor comparing a sentiment score and an emotion score of a portion of a speech, the sentiment score derived based on text corresponding to speech in the portion, the emotion score derived based on tonal data of the portion; and
the processor identifying an incongruity if the sentiment score does not correlate with the emotion score.

2. The method of claim 1, wherein the emotion score and the sentiment score are on a uniform scale.

3. The method of claim 2, wherein the sentiment score does not correlate with the emotion score if the difference therebetween satisfies a predefined threshold.

4. The method of claim 3, wherein the uniform scale is between 0 and 1, and wherein the predefined threshold is satisfied if the difference between the sentiment score and the emotion score is greater than about 0.7.

5. The method of claim 1, further comprising the processor converting the speech in the portion to text.

6. The method of claim 5, further comprising the processor generating the sentiment score based on the text.

7. The method of claim 1, further comprising the processor analyzing an audio of the portion to generate tonal data.

8. The method of claim 7, further comprising the processor generating the emotion score based on the tonal data.

9. A computing apparatus comprising:
a processor; and
a memory storing instructions that, when executed by the processor, configure the apparatus to:
compare a sentiment score and an emotion score of a portion of a speech, the sentiment score derived based on text corresponding to speech in the portion, the emotion score derived based on tonal data of the portion, and
identify an incongruity if the sentiment score does not correlate with the emotion score.

10. The computing apparatus of claim 9, wherein the emotion score and the sentiment score are on a uniform scale.

11. The computing apparatus of claim 10, wherein the sentiment score does not correlate with the emotion score if the difference therebetween satisfies a predefined threshold.

12. The computing apparatus of claim 11, wherein the uniform scale is values between 0 and 1, and wherein the predefined threshold is satisfied if the difference between the sentiment score and the emotion score is greater than about 0.7.

13. The computing apparatus of claim 9, wherein the instructions further configure the apparatus to convert the speech in the portion to text.

14. The computing apparatus of claim 13, wherein the instructions further configure the apparatus to generate the sentiment score based on the text.

15. The computing apparatus of claim 9, wherein the instructions further configure the apparatus to analyze an audio of the portion to generate tonal data.

16. The computing apparatus of claim 15, wherein the instructions further configure the apparatus to generate the emotion score based on the tonal data.

17. A non-transitory computer-readable storage medium, the computer-readable storage medium including instructions that when executed by a computer, causes the computer to:
compare a sentiment score and an emotion score of a portion of a speech, the sentiment score derived based on text corresponding to speech in the portion, the emotion score derived based on tonal data of the portion; and
identify an incongruity if the sentiment score does not correlate with the emotion score.

18. The computer-readable storage medium of claim 17, wherein the emotion score and the sentiment score are on a uniform scale.

19. The computer-readable storage medium of claim 18, wherein the sentiment score does not correlate with the emotion score if the difference therebetween satisfies a predefined threshold.

20. The computer-readable storage medium of claim 19, wherein the uniform scale is values between 0 and 1, and wherein the predefined threshold is satisfied if the difference between the sentiment score and the emotion score is greater than about 0.7.
